(19) United States
(12) Patent Application Publication
(10) Pub. No.: US 2013/0240058 A1
(43) Pub. Date: Sep. 19, 2013

(54) Basement Sewer Drain Recovery and Discharge Device

(71) Applicants: Joseph Wilson, Detroit, MI (US); Wanda Wilson, Detroit, MI (US)

(72) Inventors: Joseph Wilson, Detroit, MI (US); Wanda Wilson, Detroit, MI (US)

(21) Appl. No.: 13/721,155

(22) Filed: Dec. 20, 2012

Related U.S. Application Data
(60) Provisional application No. 61/610,264, filed on Mar. 13, 2012.

(51) Int. Cl. F16L 55/00

(52) U.S. Cl. CPC F16L 55/00
USPC 137/362

(57) ABSTRACT

Disclosed is a basement sewer drain pump housing that draws fluid from a drain and into a fluid housing, whereafter the fluid is discharged from the housing and out of the basement to prevent leakage through the floor drain. The device comprises a pickup tube having a fluid level sensor, which is placed within a sewer main drain or floor drain. The housing comprises an enclosed volume, a suction tube connected to the pickup tube, a suction pump, and a discharge pump. The pump is activated by a switch controlled by the pickup tube fluid sensor, whereby the fluid is drawn into the housing from the drain and discharged through a discharge pipe that terminates outside of the dwelling. The device operates from outlet power or battery power and serves as a basement drain pump device that prevents fluid and sewage backflow during power outages and plumbing blockages.

### CROSS REFERENCE TO RELATED APPLICATION

This application claims the benefit of U.S. Provisional Application No. 61/610,264 filed on Mar. 13, 2012, entitled “Raw Sewage Recovery System.” The above identified patent application is herein incorporated by reference in its entirety to provide continuity of disclosure.

### BACKGROUND OF THE INVENTION

1. Field of the Invention

The present invention relates to residential sewage and drainage systems. More specifically, the present invention pertains to a sewage drain pump and basement maintenance device that requires no installation and can prevent the overflow of a basement floor drain during periods of high water or as a result of a blockage in the system.

Basement floor drains are common in older residences for the purposes of draining accumulated water from the basement. The floor drain is placed at the lowest part of the house within the basement to collect water and allow it to flow into the drainage system of the rest of the house. Problems arise with this system of water removal when there is excess rainfall or when the house drainage system is clogged, either within its own limits or along its connection to an external system. When rainfall raises the water table and the household drainage system is unable to remove the water, this drain can overflow and cause water to backfill into the basement rather than drain therefrom. Similarly, when there is a clog within a combined sewage and drainage system, the clog can cause fluid, sewage and waste to flow up through the drain, contaminating a basement and causing flood damage thereto.

Several remedies to this common problem have been implemented in the art, and include standpipe structures, pumps, and sumps that either delay the backflow of fluid or remove it once the fluid has entered the basement. Sump pump devices are common in more modern homes, wherein incoming water drains to the sump location and the sump pump discharges the accumulated water from the basement before it causes damage. Traditional sump pumps are generally installed when the foundation of the home is built above the water table. Homeowners can install sump pumps if they live in a part of the country where storms often flood the basement; however sump pumps require the homeowner to make significant modifications to the basement structure and are not easily installed. These devices also do not prevent the backflow of sewage from a drain pipe, but rather collect and discharge fluid after the event.

The present invention relates to a self-contained, basement floor drain pump unit that includes a suction pump and a discharge pump for drawing fluid from within a basement main sewer drain or directly from the basement floor drain. The device pumps fluid into its housing and then discharges the waste from the basement before it enters the living space. An elongated pick-up tube is placed within the main sewer drain line or within the basement floor drain, where a fluid sensor monitors the fluid level to energize the suction pump after a threshold level is crossed. The suction pump pumps the fluid and sewage into an enclosed housing, whereafter a discharge pump energizes after the casing has filled above a given level within the casing. The discharge pump connects to an exhaust pipe that routes the fluid from the basement.

2. Description of the Prior Art

Devices have been disclosed in the prior art that relate to sewage pump systems and basement pumps. These include devices that have been patented and published in patent application publications, which generally relate to sump pump devices and other pump structures that are placed within a residential basement or have a connection with an existing floor drain. The present invention connects to a sewer main drain or floor drain, but does not impede the ability of the main drain or floor drain from normal operation when deployed. Most devices in the prior art block a floor drain port in favor of a closed system that eliminates the basic function of the drain and only considers backflow therefrom. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 4,852,609 to Schoenauer, which discloses a sump pump adapter having a tank that connects directly to a basement sewer pipe for pumping fluid that exits the pipe and into the tank using a sump pump device. A sump pump connects directly to the sewer drain pipe using a drain pipe coupler or is located adjacent thereto within the tank, where overflow from the drain triggers the sump pump to discharge fluid and sewage into an outlet pipe and out of the basement to prevent flooding and contamination. An embodiment of the device includes an elongated and upstanding standpipe within the tank such that fluid from the sewer pipe must travel the length of the standpipe and overflow into the tank before the adjacent sump pump triggers and discharges the contents into an outlet pipe. The Schoenauer device contemplates connection of a sump tank directly to a floor drain to pump overflowing contents therefrom. However, the connection of such a device over a floor drain may defeat the drain's purpose under normal operating conditions. The present invention contemplates an elongated member that is positioned within the drain to monitor for leaks, which not interfering with the drain's ability to collect and drain fluid from the basement under normal conditions.

Another device of particular relevance is U.S. Pat. No. 5,967,759 to Jurado, which discloses a basement flood control apparatus that comprises a pump unit separate from the floor and connecting to the basement floor drain and external water lines. The connection to the basement floor includes a sleeve that blocks the drain and forces backflowing contents into the pump unit. Within the pump unit casing is a first pump and auxiliary pump, whereby the first pump is energized when the water level in the unit reaches a threshold level, and the auxiliary pump energizes at a higher level. Water lines are used to clean out the system and to test the pumps between operations. The Jurado apparatus, while providing a means to draw fluid from a floor drain and pump it from a basement, utilizes a sealed floor drain configuration and diverging elements. The present invention requires no fresh water connection and is simply placed within the floor drain or a basement main sewer line. The floor drain and sewer line continues to operate as normal; however during periods of high water or blockages, backflowing liquid triggers the pumping of fluid into a housing and from the housing out of the basement.

Other patents discuss sump pump devices and housings therefor. Specifically, U.S. Published Patent Application Publication No. 2006/0093492 to Janesky discloses a sump pump reservoir housing having an oblong cross section and a first and second sump pump therein for ejecting fluid drawn into the housing. U.S. Pat. No. 6,149,390 to Fisher discloses a sump pump having motor, a primary pump and a shell enclosing the motor and pump. An indicator provides notice of the motor operation and the construction of the device keeps much of the assembly out of the water to reduce faults or damage thereto over time.

The present invention comprises a self-contained unit that is deployable in basements of older residences having flood drains that interconnect with household sewage drainage lines. The device offers a means to retrofit an existing basement without construction of a sump pump, while also diverting any backflowing wastewater from a drain pipe before it enters the basement. A pickup tube utilizes a sensor to energize a suction pump that draws the rising wastewater into a housing, whereafter it is pumped from the housing and from the residence using another pump device. It is submitted that the present invention substantially diverges in design elements from the prior art, and consequently it is clear that there is a need in the art for an improvement to existing sewage drain pump devices. In this regard the instant invention substantially fulfills these needs.

### SUMMARY OF THE INVENTION

In view of the foregoing disadvantages inherent in the known types of basement pump devices now present in the prior art, the present invention provides a new basement drain pump device that can be utilized for providing convenience for the user when preventing wastewater from backflowing into a basement through a main drain or floor drain.

It is therefore an object of the present invention to provide a new and improved drain pump device that has all of the advantages of the prior art and none of the disadvantages.

It is another object of the present invention to provide a drain pump device that is comprised of an enclosed unit that requires no installation or modification of an existing basement to deploy.

Another object of the present invention is to provide a drain pump device that is connectable to an existing basement floor drain or main drain for monitoring backflowing fluid, wherein the device does not interfere with the ability of the drain to allow fluid within the basement to escape during normal conditions.

Yet another object of the present invention is to provide a drain pump device having a suction pump and a discharge pump, the suction pump drawing sewage and fluid through a pickup tube placed within the drain, and the discharge pump sending collected fluid and sewage through a discharge tube and out of the residence.

Another object of the present invention is to provide a drain pump device having a discharge pump that monitors the fluid level within the pump housing to discharge fluid after a certain amount is collected.

Still yet another object of the present invention is to provide drain pipe that can be inserted within the main sewer drain of a residence, where the pickup tube is inserted within the main drain clean-out and sealed using a wax ring to prevent leaks and sewer gas from exiting the clean-out while installed.

A final object of the present invention is to provide a drain pump device that operates from battery power or wall outlet power for use during normal conditions and during power outage periods.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross section view of an embodiment of the present invention.

FIG. 2 shows a cross section view of another embodiment of the present invention.

FIG. 3 shows a view of the system in operation, drawing fluid from a basement flood drain and discharging it outside of the basement.

FIG. 4 shows a view of the system drawing fluid from a main sewer drain of a residence and discharging it outside of the basement.

FIG. 5 shows a cross section view of the pickup tube within a drain.

### DETAILED DESCRIPTION OF THE INVENTION

Reference is made herein to the attached drawings. Like reference numerals are used throughout the drawings to depict like or similar elements of the drain pump device. For the purposes of presenting a brief and clear description of the present invention, the preferred embodiment will be discussed as used for preventing fluid and sewage from backflowing through a drain and into a basement. The figures are intended for representative purposes only and should not be considered to be limiting in any respect.

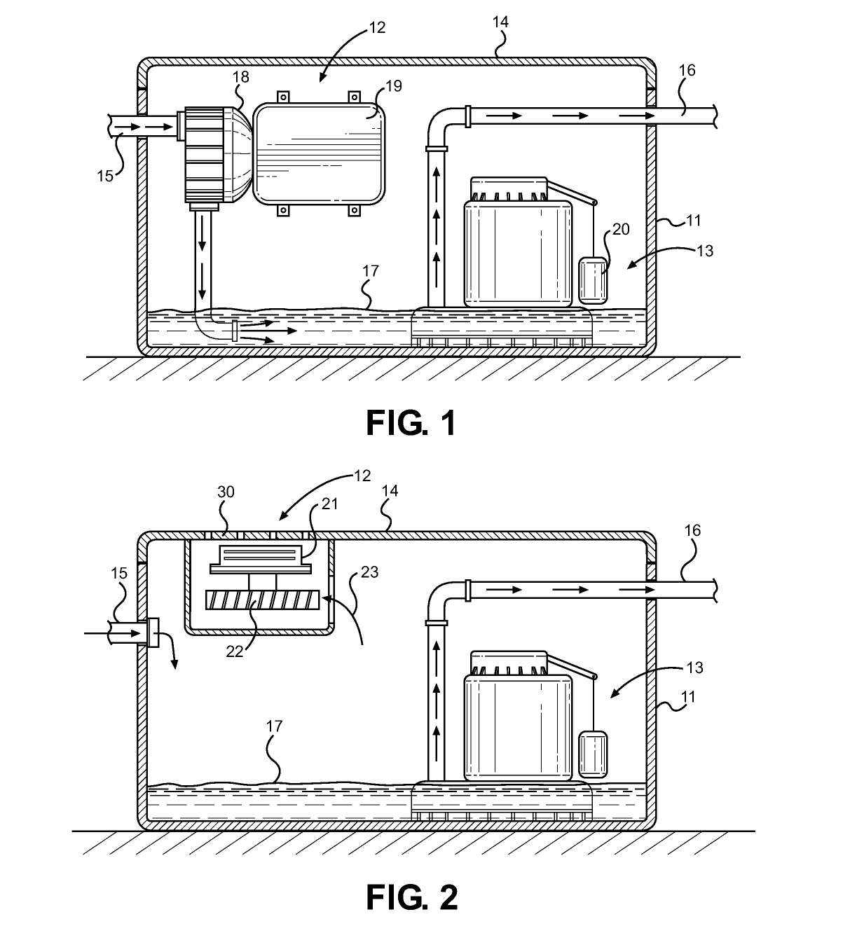

Referring now to FIG. 1, there is shown a cross section view of the basement drain pump of the present invention. The device comprises a housing 11 having a lid 14, sidewalls, and an interior volume for supporting the operational features of the system for sewage recovery and discharge. Within the housing is a suction pump 12 that connects to a suction tube 15 for drawing in fluid and sewage from a drain. The pump 12 is adapted to draw fluid from the drain to the housing 11 for collection and recovery, preventing the contents of the drain from backflowing into the house and causing flood damage. This generally occurs during periods of high water, when there is a blockage in the system or during power outages. Waste water and sewage can backflow from the household drainage system and leak into a homeowner's basement if not carefully monitored.

The pump 12 creates suction on the tube 15 once a threshold water level within the drain is detected to suck wastewater from the drain and deposit it within the housing interior. In a first embodiment, the pump 12 is a water pump comprising an electric motor 19 connected to a centrifugal pump 18 or rotary pump having an inlet and outlet. The motor 19 spins an impeller within the pump 18, creating a suction that draws liquid through the inlet and causes it to be pumped out of the outlet. The pump outlet connects to a wastewater tube that terminates within the housing 11 to allow the wastewater to collect therein. Using a water pump requires keeping the pump 12 primed. Therefore a one-way valve along the suction tube 15 keeps water within the pump between uses to prevent dry running or damage to the pump. Adjacent to the suction pump 12 and within the housing 11 is a discharge pump 13 that is adapted to monitor the level of wastewater 17 within the housing 11 and pump the fluid therefrom. The pump 13 is preferably a sump pump device or sewer pump that monitors the fluid level and pumps the fluid contents from the housing after a threshold level is passed. The fluid 17 is pumped into a discharge pipe 16 that is routed from the basement, thereby removing the sewage and wastewater from the basement before damage can occur.

The discharge pump 13 comprises an electrically driven fluid pump having an intake that is along the base of the housing 11. An electric motor drives a motor shaft connected to an impeller, which draws fluid through the intake and into the discharge pipe 16 connected to the discharge port of the pump. Operation of the pump motor is controlled by a fluid sensor of fluid level float 20, which energizes the pump 13 once a threshold fluid 17 level is reached. This type of pump is well defined in the art of sump pump and sewage pump devices, where its operation is controlled by a fluid level sensor and an electric motor drives an impeller for discharging fluid from a location. It is not desired to limit the present discharge pump to a set of elements, but rather to disclose a working embodiment that provides a fluid level-activated pump mechanism for discharging fluid 17 from the interior of the housing 11 and out of the basement.

Referring now to FIG. 2, there is shown another cross section view of the present pump system, wherein the intake pump or suction pump 12 utilizes an air vacuum within the housing 11 rather than a pump having a liquid impeller. In this embodiment, the contents of the wastewater do not directly contact a spinning impeller, causing less contamination and risk of damage to the pump itself. In this embodiment, an electric motor 21 spins a fan or air impeller 22 and the assembly is placed within an enclosure attached to the lid 14 of the housing. Along the lid 14 and above the electric motor and fan is an air exhaust port 30. The port 20 is a slotted or apertured region that allows air to be discharged from the interior of the housing 11. The fan 22, as it spins at a high rate, draws 23 in air from the housing interior into the fan enclosure, over its fan blades and out of the exhaust port 30. The high flow rate of the fan creates a vacuum within the housing that draws wastewater through the suction tube 15 and into the housing interior in a similar fashion as a wet vacuum found in most garages. This assembly allows the motor and fan to remain separated from the wastewater, but requires the housing 11 to affect a tight seal against the lid 14 such that air is only drawn through the suction tube 15 and not the surrounding environment. The discharge pump 13 remains the same between embodiments, where an electrically driven impeller pumps the fluid 17 within the housing through a discharge pipe 16 out of the user's basement.

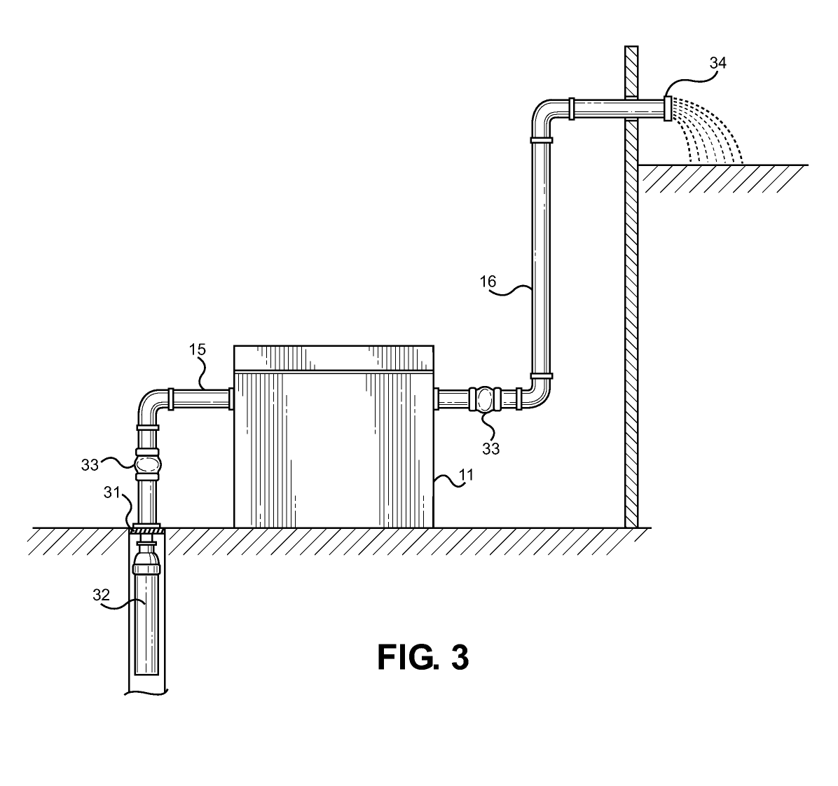

Referring now to FIG. 3, there is shown a view of the pump system in a working state, connected to a floor drain 31 and pumping fluid out of the basement and discharging the fluid to the exterior of the building. To draw fluid from the drain, an elongated pickup tube 32 is provided, which is an extension of the intake suction tube 15 that is placed within the drain 31. The pickup tube 32 includes an internal water sensor device such that when the fluid level within the pickup tube 32 reaches a certain level, the sensor activates a switch that controls the operation of the suction pump within the housing, energizing the pump and drawing the drain fluid into the pickup tube 32, through the suction hose 15 and into the housing 11. The wastewater fluid accumulates within the housing to a given level, whereafter the discharge pump energizes and sends the fluid from the housing 11 through the discharge tube 16 and out of the basement. The end of the discharge tube 16 terminates 34 along the exterior of the house and out of the basement, while a one-way valve 33 prevents fluid from backfilling into the housing once the pump ceases. Similarly on the suction hose 15 above the pickup tube 32 is another one-way valve 33 that keeps water within the suction hose 15 to prime the suction pump between uses. If the suction pump within the housing 11 is a vacuum pump, this one-way priming valve is not required.

The connection between the suction tube 15, the discharge tube 16 and the housing must be fluid tight, while the tubes 15, 16 themselves may be flexible or solid piping as desired by the user. Likewise the connection between the suction tube 15 and the drain 31 may be a secured connection, or alternatively the tube may simple be loosely positioned therein. Placement of the tube 15 into the drain is not desired to restrict fluid from entering the drain from the basement, as in normal operation, but rather the pickup tube is designed to monitor the fluid level within the drain and energize the suction pump in the event of backflowing wastewater or other fluid. The pumps themselves are ideally those suited for pumping sewage and thickened fluid, where more viscous fluids will not clog to seize the pumps during operation.

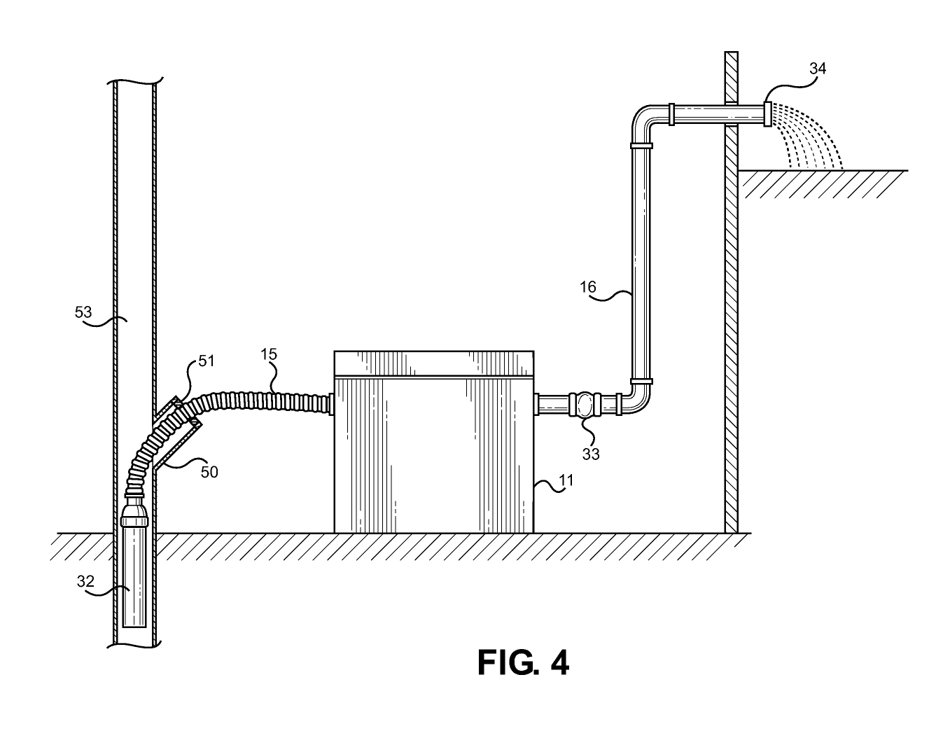

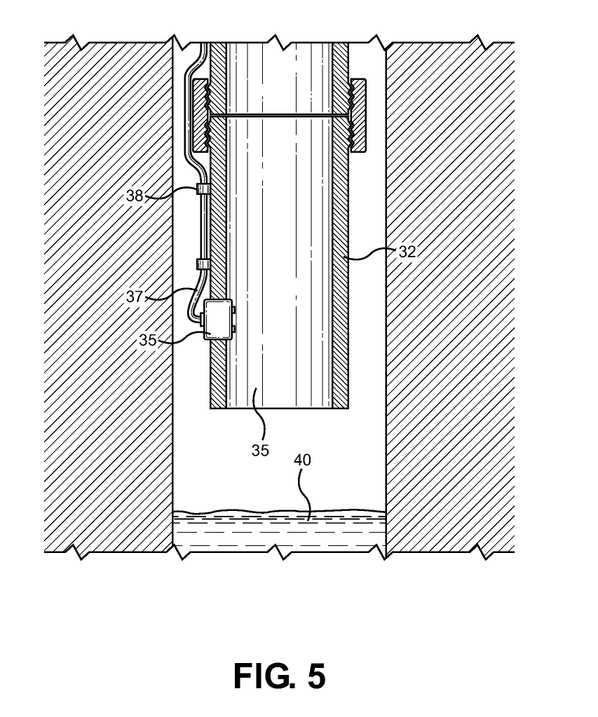

Referring now to FIG. 4, there is shown a view of the present invention in a working state and in its preferred configuration: connected to the main sewer drain 53 of a residence. The main drain 53 collects all outgoing sewer waste from the residence and is downstream from the floor drain, therefore intercepting sewage from the main drain 53 is more effective than the upstream floor drain. In this deployment, a flexible suction tube 15 is used to place the pickup tube 32 within the main drain 53 through a clean-out 50. The clean-out 50 provides access to the main drain 53 and is normally plugged. The pickup tube 32 and suction tube 15 of the present invention is adapted to remove the clean-out plug and replace it with a wax ring seal 51, which seals any gaps between the suction tube 15 and the clean-out 50. The wax ring seal 51 prevents fluid and sewer gas from the existing clean-out 50 and entering the user's home. During operation, the pickup tube 32 monitors for backflowing sewage and triggers the suction pump within the housing 11, whereafter the sewage can be recovered therein and discharged 16 outside of the home.

Referring now to FIG. 5, there is shown a cross section view of the pickup tube 32 within the drain. In this view, the interior of the tube 32 and the water sensor 36 are visualized. The water sensor 36 is an electrical device that closes a switch that controls the suction pump within the pump housing. When the water level 40 reaches the level of the sensor 36, the suction pump energizes to draw the water through the tube 32 and into the housing to be discharged. This in turn monitors the fluid level 40 within the drain and prevents water from flowing out of the drain and into the interior of one's basement. The water sensor 36 may be any suitable electrical assembly that is capable of detecting the presence of water and sending signals to a switch to control the suction pump. It is not desired to limit the present invention to the structural layout or design show in FIG. 5, but rather it is desired to show a working embodiment where the sensor is secured through the tube sidewall and wired 37 to the pump within the housing. The wire connections 37 preferably run along the exterior of the pickup tube 32, where they are secured 38 along regular intervals and kept away from contact with the wastewater within the drain. The preferred placement of the sensor 35 is at least one foot inward from the end of the pickup tube opening so as to prevent short-cycling of the pumps and false triggers from inadvertent contact with water that is not truly a backflow warranting the suction pump activation.

In operation, the present invention is design for those homes having combined sewage and drainage systems, which are common in older homes. The device is an independent structure that can be rapidly deployed in an emergency situation or provide constant vigilance for such basement structures. The device power source is ideally outlet power; however battery pack backup may be utilized in the event of power outages. This is particularly useful during storm events, where the area is likely to flood and simultaneously cut off power to many homes.

The present invention describes a fluid suction pump and discharge pump system that is installed within a housing container. The discharge pump is ideally a sump or sewage pump style device while the suction pump may be a liquid or air suction pump. A built-in water sensor within the suction pick-up tube detects the water pressure or an elevation change such that the suction pump is energized to draw fluid into the container. Fluid is drawn into the container by a suction, which is then pumped by the discharge pump from the container and out of the basement. The present invention removes sewage and sewage gas before the main drain or floor drain backs up and allows sewage into the homeowner's basement. The suction system draws the backup water into the container reservoir. Users finding themselves in a flood zone or living in older style homes having combined sewage and drainage systems will appreciate the ease of deployment and application of the present invention to prevent flood and sewage damage in a basement environment.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A basement drain sewage recovery and discharge device, comprising:
a container housing having a base, upstanding sidewalls, an interior volume, and a lid;
a suction pump;
a discharge pump;
a power source;
a pickup tube connecting to a suction tube, said suction tube connecting to said suction pump within said housing for drawing fluid into said housing;
said discharge pump connecting to a discharge tube for discharging said fluid out of said housing.

2) The device of claim 1, where said pickup tube further comprises fluid level sensor and suction pump switch, wherein detection of fluid beyond a threshold level activates the pump switch and energizes said suction pump.

3) The device of claim 1, wherein said suction pump further comprises:
a water pump having an electric motor driving an impeller having an inlet and outlet;
said suction tube through said inlet;
said impeller suctioning fluid through said inlet and out said outlet into said container interior.

4) The device of claim 1, wherein said suction pump further comprises:
an air vacuum pump having an electric motor driving a vacuum impeller fan;
said electric motor and fan secured within an enclosure attached to said lid;
said lid further comprising an exhaust port above said enclosure;
said enclosure having an opening such that air is drawn from said container interior and out of said exhaust port to draw suction on said suction tube.

5) The device of claim 1, wherein said discharge pump further comprises:
an electric motor driving an impeller;
a base comprises an intake;
a discharge port connecting to said discharge tube;
a fluid level sensor for energizing said electric motor when a fluid level within said container interior reaches a threshold level.

6) The device of claim 5, wherein said fluid level sensor further comprises a float.

7) The device of claim 1, wherein said pickup tube further comprises an elongated tubular member adapted to be placed within a drain interior.

8) The device of claim 1, wherein said discharge tube further comprises a one-way valve to prevent backflow of fluid into said container.

9) The device of claim 1, wherein said suction tube further comprises a one-way valve to prime said pump.

10) The device of claim 1, wherein said power source is outlet wall power.

11) The device of claim 1, wherein said power source is battery power.

12) The device of claim 1, wherein said suction tube comprises a flexible hose.

13) The device of claim 1, wherein said drain further comprises a main drain, wherein said pickup tube and suction tube are positioned within a main drain clean-out and sealed to prevent fluid and sewage gas from exiting said clean-out.

14) The device of claim 1, where said drain further comprises a basement floor drain, wherein said pickup tube and suction tube are positioned therein.
